(19) United States
(12) Patent Application Publication
(10) Pub. No.: US 2008/0062142 A1
(43) Pub. Date: Mar. 13, 2008

(54) Touch panel having high environmental durability and manufacturing method thereof

(75) Inventor: Shozo Furukawa, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Component Limited, Tokyo (JP)

(21) Appl. No.: 11/898,370

(22) Filed: Sep. 11, 2007

(30) Foreign Application Priority Data
Sep. 11, 2006 (JP) 2006-245606

(51) Int. Cl. G06F 3/041

(52) U.S. Cl. 345/173

(57) ABSTRACT

A touch panel including an upper electrode plate including a plastic film base plate and a transparent conductive film provided on a first surface of the plastic film base plate; and a lower electrode plate including a glass base plate and a transparent conductive film applied to a surface of the glass base plate. The upper electrode plate is combined with the lower electrode plate with respective transparent conductive films thereof being opposed to and spaced from each other at location allowing electrical contact therebetween. The upper electrode plate also includes an upper glass plate arranged along a second surface of the plastic film base plate, opposite to the first surface on which the transparent conductive film is provided. An adhesive layer is provided between the plastic film base plate and the upper glass plate, for fixing a first surface of the upper glass plate, in its entirely, to the second surface of the plastic film base plate.

### BACKGROUND OF THE INVENTION

1. Field of the Invention

The present invention relates to a touch panel and a manufacturing method thereof.

2. Description of the Related Art

A touch panel, on which an upper electrode plate and a lower electrode plate respectively having a transparent conductive film made of ITO (indium-tin oxide) are opposed to each other leaving a predetermined interval, detects a pressed position by an electrical contact when the upper electrode plate is pressed by a finger tip so as to make a transparent conductive film of the upper electrode plate come into contact with a transparent conductive film of the lower electrode plate. Accordingly, the upper electrode plate to be directly pressed by the finger tip must be somewhat flexible and the lower electrode plate must be rigid so that it can endure a pressing force. Therefore, it is common that the upper electrode plate is formed out of a plastic film made of polyethylene terephthalate (PET) on which the transparent conductive film is formed by the method of sputtering.

It is also common that the lower electrode plate be formed of a glass plate on which the transparent conductive film is formed by the same method.

Japanese Unexamined Patent Publication (kokai) No. 2005-284603 discloses a touch panel on which thermal stress acting on the transparent conductive film is reduced so that the life of the touch panel can be extended. An upper electrode plate of this touch panel is made of a plastic film and a lower electrode plate is made of a glass base plate. Further, on the upper electrode plate, a hard coat layer made of heat-resistant acrylic resin is provided. In this structure, a coefficient of friction of a touch pen with respect to the hard coat layer is low enough that it is possible to suppress the generation of frictional heat. Therefore, thermal stress acting on the transparent conductive film can be reduced.

Japanese Patent Publication No. 2619921 discloses a touch panel. On the touch panel, on a transparent insulating base material on the side on which external light is incident, an ultraviolet ray shielding layer is provided.

Therefore, ultraviolet rays are prevented from causing an error in detecting the pressed position. In this case, an embodiment is disclosed in which the upper electrode plate is formed out of a plastic film and the lower electrode is formed out of a glass base plate. Further, on the upper electrode plate, a glass plate is provided which serves as an ultraviolet ray shielding layer.

On the touch panel disclosed in Japanese Unexamined Patent Publication (kokai) No. 2005-284603, the upper electrode plate is formed out of a plastic film and the lower electrode plate is formed out of a glass plate, which will be referred to as “a film-glass structure”, hereinafter. Therefore, when environmental conditions (humidity and temperature) are dramatically changed, the plastic film on the upper electrode plate is stressed by the difference between the expansion coefficient of the upper electrode plate and that of the lower electrode plate. Therefore, electrical malfunction of a transparent conductive film or electrical leader may be caused. Accordingly, there is a possibility that the upper electrode plate may be peeled off from the lower electrode plate.

On the touch panel disclosed in Japanese Patent Publication No. 2619921, a glass plate is provided on the upper electrode plate. However, the object of this glass plate is to only shield ultraviolet rays. Accordingly, when the glass plate and the upper electrode plate are laminated on each other along the outer edges by the same laminating method as that of laminating the upper electrode and the lower electrode on each other, the upper electrode plate is highly stressed by the difference between the expansion coefficient of the upper glass plate and that of the lower glass plate (between the lower electrode plate and the ultraviolet ray shielding layer) at the time of a dramatic change in environmental conditions (temperature and humidity).

### SUMMARY OF THE INVENTION

An object of the present invention is to provide a touch panel in which physical stress is prevented from being generated between an upper electrode plate and a lower electrode plate even when the touch panel is used in an environment in which temperature or humidity is drastically changed, and in which the occurrence of electrical malfunction of a transparent conductive film or an electrical leader is prevented and the upper electrode plate is prevented from peeling off from the lower electrode plate.

In order to accomplish the above object, the present invention provides a touch panel and a manufacturing method of manufacturing the touch panel, the characteristics of which are as follows.

In the present invention, a touch panel includes: an upper electrode plate including a plastic film base plate and a transparent conductive film provided on a first surface of the plastic film base plate; and a lower electrode plate including a glass base plate and a transparent conductive film provided on a surface of the glass base plate; the upper electrode plate being combined with the lower electrode plate with respective transparent conductive films thereof being opposed to and spaced from each other at locations allowing an electrical contact therebetween, and the upper electrode plate also includes: an upper glass plate arranged along a second surface of the plastic film base plate, opposite to the first surface on which the transparent conductive film is provided; and an adhesive layer provided between the plastic film base plate and the upper glass plate, for fixing a first surface of the upper glass plate, in its entirety, to the second surface of the plastic film base plate.

In the above touch panel, the upper electrode plate may further include an optical function member arranged on a second surface of the upper glass plate opposite to the first surface of the upper glass plate.

Also, the optical function member may include a plastic film subjected to an anti-glare treatment and a hard coat treatment.

The optical function member may include a polarizing plate.

The optical function member may include a ¼ wavelength plate.

An anti-friction and soil-resistant treatment may be carried out on the outermost face of the optical function member.

The present invention also provides a method for manufacturing a touch panel, comprising: providing an upper electrode plate including a plastic film base plate and a transparent conductive film provided on a first surface of the plastic film base plate; providing a lower electrode plate including a glass base plate and a transparent conductive film provided on a surface of the glass base plate; combining the upper electrode plate with the lower electrode plate with respective transparent conductive films thereof being opposed to and spaced from each other at locations allowing an electrical contact therebetween; arranging an upper glass plate along a second surface of the plastic film base plate opposite to the first surface, and providing an adhesive layer between the upper glass plate and the plastic film base plate for fixing a first surface of the upper glass plate, in its entirely, to the second surface of the plastic film base plate.

### BRIEF DESCRIPTION OF THE DRAWINGS

The above and other objects, features and advantages of the present invention will become more apparent from the following description of preferred embodiments in connection with the accompanying drawings, wherein:

FIG. 1 is a sectional view showing a touch panel of the first embodiment;

FIG. 2 is a sectional view showing a touch panel of the second embodiment;

FIG. 3 is a sectional view showing a touch panel of the third embodiment;

FIG. 4 is a sectional view showing a touch panel of the fourth embodiment; and

FIG. 5A to 5D are views showing a process of manufacturing a touch panel having an upper glass plate or a member in which an optical function member is laminated onto the upper glass plate, wherein FIG. 5 A is a view showing the laminating of an upper electrode plate and a lower electrode plate on each other, FIG. 5B is a view showing the attaching of an electrical leader to the lower electrode plate with pressure, FIG. 5C is a view showing the laminating of the upper glass plate onto the upper electrode plate and FIG. 5D is a view showing the laminating of a member, which is formed when an optical function member is laminated onto the upper glass plate, onto the upper electrode plate.

### DESCRIPTION OF THE PREFERRED EMBODIMENTS

The embodiments of the present invention are described below in detail, with reference to the accompanying drawings. In the drawings, the same or similar components are denoted by common reference numerals.

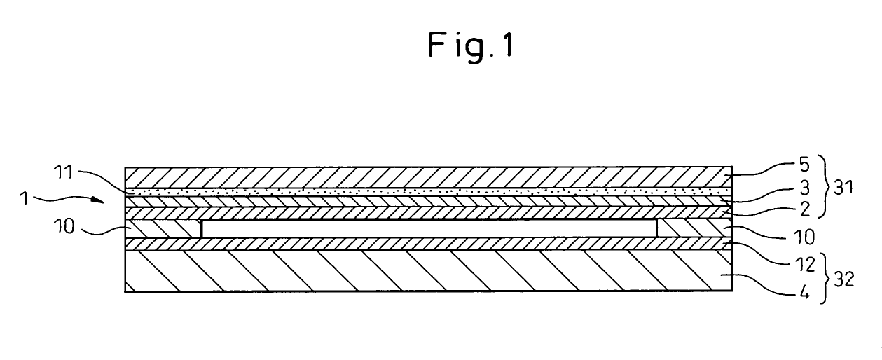

FIG. 1 is a view showing a touch panel 1 of the first embodiment of the present invention. The touch panel 1 includes: an upper electrode plate 31 including a plastic film base plate 3 and a transparent conductive film 2 provided on a first surface of the plastic film base plate 3; and a lower electrode plate 32 including a glass base plate 4 and a transparent conductive film 12 provided on a surface of the glass base plate 4. The upper electrode plate 31 being combined with the lower electrode plate 32 with respective transparent conductive films 2 thereof being opposed to and spaced from each other at locations allowing an electrical contact therebetween. Specifically, an adhesive member 10 such as an adhesive tape is laminated on an outer edge of the lower electrode plate 32 and then the upper electrode plate 31 is arranged and laminated on the lower electrode plate 32. The upper electrode plate 31 includes: an upper glass plate 5 arranged along the second surface of the plastic film base plate 3, opposite to the first surface on which the transparent conductive film 2 is provided; and an adhesive layer 11 provided between the plastic film base plate 3 and the upper glass plate 5, for fixing a first surface of the upper glass plate 5, in its entirely, to the second surface of the plastic film base plate 3. Specifically, an adhesive agent is applied onto the first surface of the upper glass plate 5. By this adhesive layer 11, the upper glass plate 5 is laminated onto the second surface on the opposite side to the surface on which the transparent conductive film 2 of the plastic film base plate 3 is provided. Due to the above structure, there is no difference between the expansion coefficient of the upper glass plate 5 on the plastic film base plate 3 and that of the glass base plate 4. Therefore, no physical stress is generated on the plastic film base plate 3. Accordingly, an electrical malfunction of the transparent conductive films 2, 12 or the electrical leader 9 (shown in FIG. 6) is prevented and the upper electrode plate 31 is prevented from peeling off from the lower electrode plate 32.

The thickness of the upper electrode plate 31 may be set at 0.02 to 0.2 mm and the thickness of the glass base plate 5 may be set at 0.05 to 0.5 mm so that the touch panel can be bent without being cracked at the time of pressing. When the plastic film of the plastic film base plate 3 is made of polyethylene terephthalate (PET), manufacturing costs can be further reduced because this material is widely used.

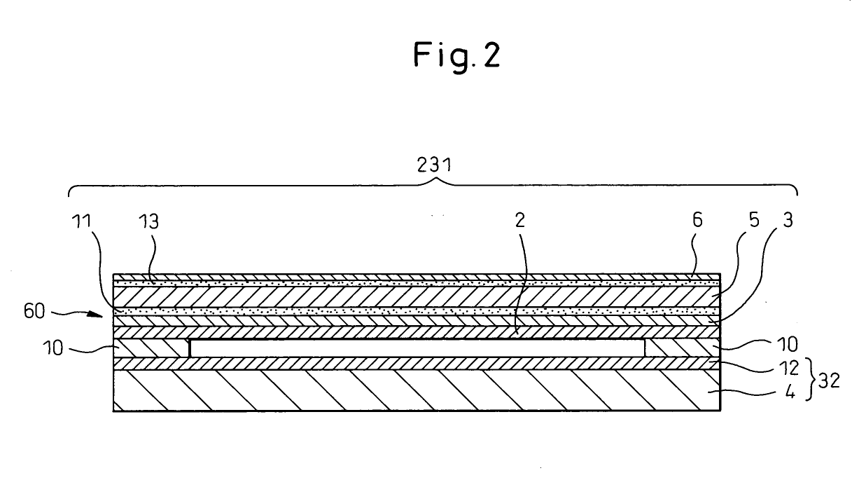

FIG. 2 is a view showing a touch panel 60 of the second embodiment.

On the touch panel 60, an optical function member 6 is further arranged on a second surface of the upper glass plate 5 of the upper electrode plate 231 through the adhesive layer 13 which spreads all over the optical function member 6, except that, the touch panel 60 of this embodiment is composed in the substantially same manner as the touch panel 1 of the first embodiment. Therefore, the same or similar components are denoted by common reference numerals and the explanations are omitted here. The upper electrode plate 231 further includes the optical function member 6 which is arranged on a second surface opposite to the first surface of the upper glass plate 5. Specifically, an adhesive agent is applied to the surface of the optical function member 6, which is laminated onto the glass plate 5 by the adhesive layer 13. In this case, “the optical function member” is a member capable of improving the visibility of the touch panel when the touch panel is viewed through this member. This optical function member 6 is formed out of a plastic film and so forth. It is possible that the optical function member 6 includes a plastic film subjected to the anti-glare treatment and the hard coat treatment. When the anti-glare treatment is applied to the plastic film, light reflected can be dispersed. Therefore, it is possible to provide a glare-proof effect. Further, when the hard coat treatment is performed on the plastic film, it is possible to prevent scratches from being generated when the touch panel is touched.

Further, the plastic material of the plastic film base plate 3 of the upper electrode plate 231 can be made of one of polycarbonate (PC), polyethersulfone (PES), polysulfone (PSF) and polyolefin (PO) having the optical isotropy. Furthermore, the optical function member 6 can include a polarizing plate 16. When the optical function member 6 is formed out of the polarizing plate 16, it is possible to reduce reflection of external light so as to enhance the contrast of the image plane display, and at the same time, visibility can be enhanced.

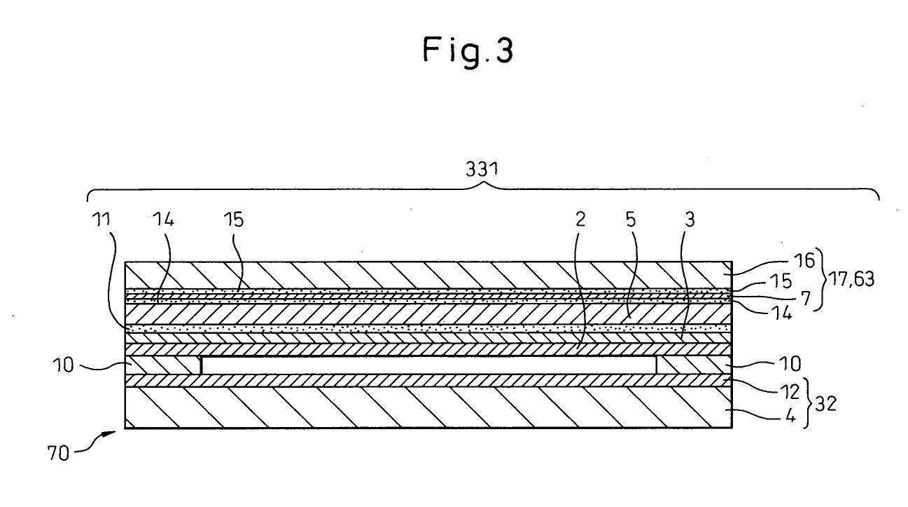

FIG. 3 is a view showing a touch panel 70 of the third embodiment. On the touch panel 70, a polarizing plate 16 and a ¼ wave-length plate 7, which are used as an optical function member 63, are arranged on the glass plate 5 of the upper electrode plate 331. Except for that, the touch panel 70 of this embodiment is composed in the substantially same manner as the touch panel 1 of the first embodiment. Therefore, the same or similar components are denoted by common reference numerals and the explanations are omitted here. The optical function member 63 can include a ¼ wave-length plate 7. In the present embodiment, the optical function member 63 is composed in such a manner that the polarizing plate 16 and the ¼ wave-length plate 7 are laminated on each other by the adhesive layer 15. Further, the ¼ wave-length plate 7 is laminated onto the glass plate 5 by the adhesive layer 14. When the polarizing plate 16 and the ¼ wave-length plate 7 are laminated on each other, a circularly polarizing plate 17 is formed.

The aforementioned anti-glare treatment and the hard coat treatment may be applied to the polarizing plate 16. Further, the plastic material of the plastic film base plate 3 can be made of one of polycarbonate (PC), polyethersulfone (PES), polysulfone (PSF) and polyolefin (PO) having the optical isotropy. Due to the foregoing, it is possible to reduce reflection of the external light so as to enhance contrast of the image plane display. At the same time, the visibility can be enhanced. Further, by the circularly polarizing plate 17, reflection of the external light can be reduced. In other words, it is possible to prevent reflection of external light on the transparent conductive film. Further, light sent from a liquid crystal display can be transmitted without a loss.

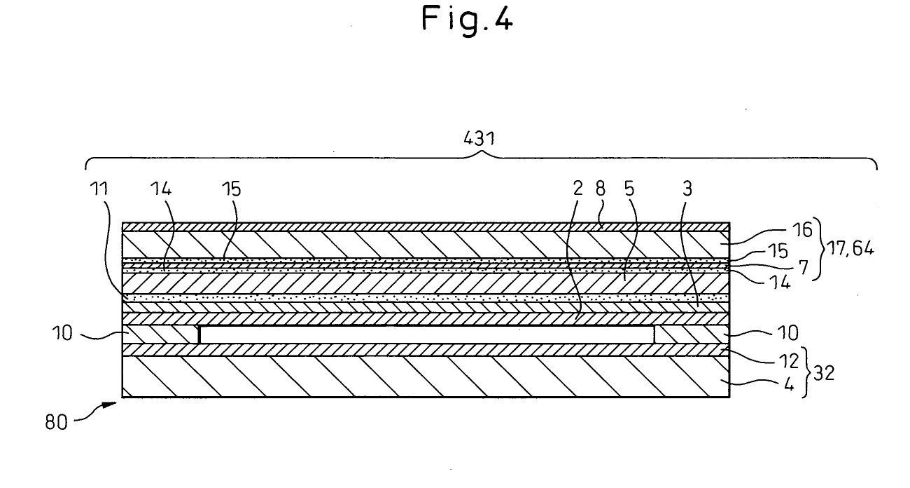

FIG. 4 is a view showing a touch panel 80 of the fourth embodiment. On the touch panel 80, an anti-reflection treatment and a soil-resistant treatment 8 are performed on a surface of the optical function member 64 of the upper electrode plate 431 by the method of spattering or coating, except that, the touch panel of the present embodiment is composed in the substantially same manner as that of the touch panel 70 of the third embodiment. Therefore, the same or similar components are denoted by common reference numerals and the explanations are omitted here.

On the outermost face of the optical function member 64, the anti-friction treatment and the soil-resistant treatment 8 are performed. Specifically, the anti-friction treatment and the soil-resistant treatment 8 are a metallic oxide film or a fluorine coating for the prevention of soil provided on a surface of the polarizing plate 16 of the optical function member 64. Due to this, reflection of the external light can be reduced and transmission of the display light can be further enhanced.

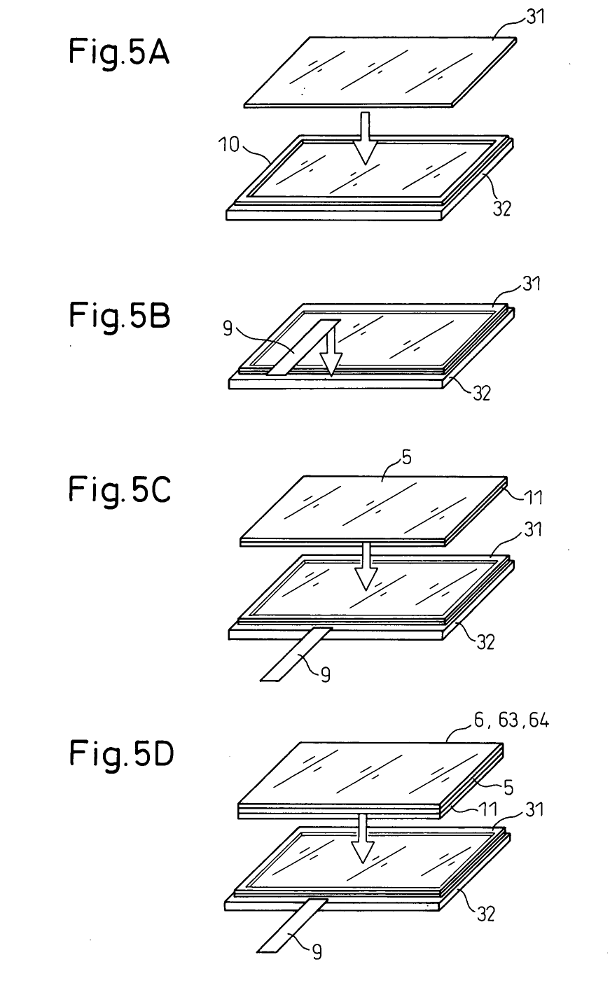

Next, a method of manufacturing the touch panel 1 of the first embodiment will be described below. FIG. 5A is a view showing laminating the upper electrode 31 and the lower electrode 32 on each other. FIG. 5B is a view showing a state in which the electrical leader 9 is tightly contacted to the lower electrode plate 32 with pressure. FIG. 5C is a view showing a state in which the glass plate 5 is laminated on the upper electrode 31.

The touch panel manufacturing method of the present invention includes an upper electrode plate 31, including a plastic film base plate 3 and a transparent conductive film 2 provided on a first surface of the plastic film base plate 3; and providing a lower electrode plate 32 including a glass base plate 4 and a transparent conductive film 12 provided on a surface of the glass base plate 4. The touch panel manufacturing method of the present invention further includes combining the upper electrode plate 31 and the lower electrode plate 32 are combined and opposed to each other so that the respective transparent conductive films 2, 12 can be electrically contacted with and separated from each other. The touch panel manufacturing method of the present invention further includes forming the upper electrode plate 31 in such a manner that the upper glass plate 5 is arranged on a second surface of the plastic film base plate 3 on the opposite side to the surface on which the transparent conductive film 2 is provided and the entire upper glass plate 5 is fixed to the second surface by adhesive.

In the embodiment shown in the drawing, the manufacturing process of manufacturing a touch panel includes combining the upper electrode plate 31 with the lower electrode plate 32 with respective transparent conductive films 2, 12 thereof being opposed to and spaced from each other at locations allowing an electrical contact therebetween. As shown in FIG. 5A, the adhesive member 10 such as an adhesive tape is laminated on the outer edge of the lower electrode plate 31 and then the upper electrode 31 is arranged and laminated on the lower electrode plate 31. Next, the manufacturing process of manufacturing a touch panel includes attaching the electrical leader 9 to the lower electrode plate 32 by pressure. An example of the electrical leader 9 is FPC (flexible printed wiring board). Concerning this matter, please refer to FIG. 5B. Next, the manufacturing process of a touch panel includes arranging an upper glass plate 5 along a second surface of the plastic film base plate 3 opposite to the first surface, and providing an adhesive layer 11 between the upper glass plate 5 and the plastic film base plate 3 for fixing a first surface of the upper glass plate 5, in its entirely, to the second surface of the plastic film base plate 3. An adhesive agent is coated on all the surface of the upper glass plate 5. By this adhesive layer 11, the glass plate 5 is laminated on the upper electrode plate 31. Concerning this mater, please refer to FIG. 5C. As described above, in addition to the usual manufacturing process of manufacturing a film-glass base plate, it is sufficient to add laminating the upper glass plate 5 on the upper electrode plate 31. Therefore, the production line is not greatly changed, and it is possible to manufacture a touch panel, the cost performance of which is excellent, capable of being applied in a harsh environment (temperature and humidity).

Further, in order to manufacture touch panels 60 of the second, third and fourth embodiments, as shown in FIG. 5D, the optical function members 6, 63, 64 of the second, third and fourth embodiments may be laminated on the glass plate 5.

According to the invention, on the second surface of the plastic film base plate of the upper electrode plate, opposite to the first surface on which the transparent conductive film is provided, the upper glass plate is provided through the adhesive layer spreading on a first surface of the upper glass plate, in its entirely. Due to this structure, no difference is made between the expansion coefficient of the upper glass plate on the upper electrode plate and that of the glass base plate of the lower electrode plate. Therefore, no physical stress is generated on the plastic film of the upper electrode plate. Accordingly, there is no possibility that an electrical malfunction may occur on the transparent conductive film and in the electrical leader. Further, there is no possibility that the upper electrode plate may peel off from the lower electrode plate.

According to the invention, the optical function member may be further arranged on a second surface of the upper glass plate of the upper electrode plate. Therefore, the visibility of the touch panel can be improved.

According to the invention, the optical function member may include a plastic film subjected to the anti-glare treatment and the hard coat treatment. Therefore, reflecting light can be dispersed by an effect provided by the anti-glare treatment, and a glare shielding effect can be provided. Further, by an effect provided by the hard coat treatment, it is possible to prevent scratches from being generated on the touch panel.

According to the invention, the optical function member may include a polarizing plate. Therefore, reflection of the external light is reduced and the contrast of the display on the image plane is enhanced. Further, it is possible to enhance the visibility.

According to the invention, the optical function member may include a ¼ wave-length plate. Therefore, when the wave-length plate is joined to the polarizing plate, a circularly polarizing plate is formed and the reflection of external light can be reduced.

According to the invention, the outermost face of the optical function member may be subjected to an anti-reflection treatment and a soil-resistant treatment. Therefore, reflection of the external light can be reduced and transmission of the display light can be enhanced.

According to the invention, on the second surface of the plastic film base plate of the upper electrode plate on the opposite side to the first surface on which the transparent conductive film is provided, the upper glass plate may be arranged. The entire upper glass plate is fixed to the second surface of the plastic film base plate by an adhesive so as to form the upper electrode. Therefore, it is sufficient to add the step of laminating the upper glass plate onto the plastic film base plate of the upper electrode, to the present production step. Accordingly, without greatly changing the production line, a touch panel can be manufactured which can endure a drastic environmental change (change in the temperature and humidity). Accordingly, costs can be reduced.

While the invention has been described with reference to specific preferred embodiments, it will be understood, by those skilled in the art, that various changes and modifications may be made thereto without departing from the spirit and scope of the following claims.

1. A touch panel comprising:
an upper electrode plate including a plastic film base plate and a transparent conductive film provided on a first surface of the plastic film base plate; and
a lower electrode plate including a glass base plate and a transparent conductive film provided on a surface of the glass base plate; the upper electrode plate being combined with the lower electrode plate with respective transparent conductive films thereof being opposed to and spaced from each other at locations allowing electrical contact therebetween,
the upper electrode plate also including:
an upper glass plate arranged along a second surface of the plastic film base plate, opposite to the first surface on which the transparent conductive film is provided; and
an adhesive layer provided between the plastic film base plate and the upper glass plate, for fixing a first surface of the upper glass plate, in its entirely, to the second surface of the plastic film base plate.

2. A touch panel according to claim 1, wherein the upper electrode plate further includes an optical function member arranged on a second surface of the upper glass plate opposite to the first surface of the upper glass plate.

3. A touch panel according to claim 2, wherein the optical function member comprises a plastic film subjected to an anti-glare treatment and a hard coat treatment.

4. A touch panel according to claim 2, wherein the optical function member comprises a polarizing plate.

5. A touch panel according to claim 3, wherein the optical function member comprises a polarizing plate.

6. A touch panel according to claim 4, wherein the optical function member includes a ¼ wavelength plate.

7. A touch panel according to claim 5, wherein the optical function member includes a ¼ wavelength plate.

8. A touch panel according to claim 2, wherein an anti-friction treatment and soil-resistant treatment are applied to an outermost face of the optical function member.

9. A touch panel according to claim 3, wherein an anti-friction treatment and a soil-resistant treatment are applied to an outermost face of the optical function member.

10. A touch panel according to claim 4, wherein an anti-friction treatment and a soil-resistant treatment are applied to an outermost face of the optical function member.

11. A touch panel according to claim 5, wherein an anti-friction treatment and a soil-resistant treatment are applied to an outermost face of the optical function member.

12. A touch panel according to claim 6, wherein an anti-friction treatment and a soil-resistant treatment are applied to an outermost face of the optical function member.

13. A touch panel according to claim 7, wherein an anti-friction treatment and a soil-resistant treatment are applied to an outermost face of the optical function member.

14. A method for manufacturing a touch panel comprising:
providing an upper electrode plate including a plastic film base plate and a transparent conductive film provided on a first surface of the plastic film base plate;
providing a lower electrode plate including a glass base plate and a transparent conductive film provided on a surface of the glass base plate;
combining the upper electrode plate with the lower electrode plate with respective transparent conductive films thereof being opposed to and spaced from each other at locations allowing an electrical contact therebetween;
arranging an upper glass plate along a second surface of the plastic film base plate opposite to the first surface, and applying an adhesive layer between the upper glass plate and the plastic film base plate for fixing a surface of the upper glass plate, in its entirely, to the second surface of the plastic film base plate.
